(19) United States
(12) Patent Application Publication
(10) Pub. No.: US 2026/0131843 A1
(43) Pub. Date: May 14, 2026

(54) LAYOVER FIXTURE

(71) Applicant: Crown Equipment Corporation, New Bremen, OH (US)

(72) Inventors: Nicholas J. Schlater, North Star, OH (US); John F. Hemmelgarn, Coldwater, OH (US); Andrew K. Seger, Minster, OH (US)

(21) Appl. No.: 19/386,332

(22) Filed: Nov. 12, 2025

Related U.S. Application Data
(60) Provisional application No. 63/719,730, filed on Nov. 13, 2024.

(51) Int. Cl. B62B 15/00; B66F 19/00

(52) U.S. Cl. CPC B62B 15/007; B66F 19/00

(57) ABSTRACT

A layover fixture for transitioning an industrial vehicle between an upright position and a laid-over position includes a frame that supports the industrial vehicle in the laid-over position on a floor surface, wherein the frame defines a longitudinal direction and a lateral direction transverse to the longitudinal direction. The fixture further includes a heal structure that is coupled to the frame and includes a curved surface for gripping the floor surface while the layover fixture is being used to transition the industrial vehicle between the upright position and the laid-over position. An adjustment mechanism is associated with the heal structure, wherein the adjustment mechanism is for adjusting a position of the heal structure relative to the frame in the longitudinal direction of the frame.

### CROSS REFERENCE TO RELATED APPLICATION

This application claims the benefit of U.S. Provisional Patent Application Ser. No. 63/719,730, filed Nov. 13, 2024, entitled “LAYOVER FIXTURE”, attorney docket 2311/CRN 1107 MA, the entire disclosure of which is hereby incorporated by reference herein.

### FIELD

The present disclosure relates to industrial vehicles, and more particularly, to a layover bracket system for industrial vehicles.

### BACKGROUND

Industrial vehicles, such as forklift trucks, may include a power unit, a mast assembly, and an operator platform. When transported between facilities, it is generally preferable to lay the industrial vehicle over onto its back or side due to the height of the vehicle when standing upright.

### BRIEF SUMMARY

In accordance with various aspects of embodiments, a layover fixture for transitioning an industrial vehicle between an upright position and a laid-over position is disclosed. The layover fixture comprises a frame that supports the industrial vehicle in the laid-over position on a floor surface, the frame defining a longitudinal direction and a lateral direction transverse to the longitudinal direction. The layover fixture further includes a heal structure coupled to the frame and including a curved surface for gripping the floor surface while the layover fixture is being used to transition the industrial vehicle between the upright position and the laid-over position, and an adjustment mechanism associated with the heal structure, the adjustment mechanism for adjusting a position of the heal structure relative to the frame in the longitudinal direction of the frame.

The adjustment mechanism may comprise a threaded rod coupled to the heal structure and an adjustment portion for rotating the threaded rod to adjust the position of the heal structure relative to the frame in the longitudinal direction of the frame. The heal structure may include a recess for receiving an end portion of the threaded rod of the adjustment mechanism.

The adjustment mechanism may be positioned within a recess of the frame such that the adjustment mechanism does not protrude beyond the outer contour of the frame.

The layover fixture may further comprise a second heal structure coupled to the frame, the second heal structure including a curved surface for gripping the floor surface while the layover fixture is being used to transition the industrial vehicle between an upright position and a laid-over position, and a second adjustment mechanism associated with the second heal structure, the second adjustment mechanism for adjusting a position of the second heal structure relative to the frame in the longitudinal direction of the frame. The two heal structures may be coupled to opposed lateral sides of the frame.

The two adjustment mechanisms may be positioned within recesses provided in respective laterally outer first and second side beams of the frame such that the two adjustment mechanisms do not protrude beyond the outer contour of the frame.

The two heal structures may be adjustable in the longitudinal direction of the frame independently of each other via the respective adjustment mechanisms.

The curved outer surface of the heal structure may comprise an insert for gripping the floor surface while the layover fixture is being used to transition the industrial vehicle between an upright position and a laid-over position.

The heal structure may be adjustable from a retracted position wherein an inner surface of the heal structure may be adjacent to an edge of a plate structure of the frame, through an extended position, wherein the inner surface of the heal structure may be distal from the edge of the plate structure of the frame in the longitudinal direction of the frame.

The frame may further comprise a first laterally outer side beam extending in the longitudinal direction, a second laterally outer side beam extending in the longitudinal direction and opposed from the first laterally outer side beam in the lateral direction, and a plurality of cross beams extending in the lateral direction between the first and second laterally outer side beams. The frame may further include a first support portion that supports a body portion of the industrial vehicle, and a second support portion that supports a mast assembly of the industrial vehicle, the second support portion raised from the first support portion in a third direction that is transverse to the longitudinal direction and to the lateral direction, wherein the heal structure may be coupled to an end portion of the first laterally outer side beam of the frame.

The layover fixture may further comprise a second heal structure coupled to an end portion of the second laterally outer side beam of the frame, the second heal structure including a curved surface for gripping the floor surface while the layover fixture is being used to transition the industrial vehicle between an upright position and a laid-over position, and a second adjustment mechanism associated with the second heal structure, the second adjustment mechanism for adjusting a position of the second heal structure relative to the frame in the longitudinal direction of the frame.

The heal structure may be generally centered along a lateral axis of the frame that extends in the lateral direction of the frame.

The layover fixture may further comprise a plurality of stacking caps for stacking a second layover fixture on top of the layover fixture when the layover fixture is not being used to support an industrial vehicle, a pair of fork pockets for receiving forks of a transporting vehicle that is used to move the layover fixture from a first location to a second location, or an accessory support structure for securing spare parts or accessories associated with the industrial vehicle to the layover fixture.

The layover fixture may further comprise one or more support areas on the frame for receiving dunnage for supporting portions of the industrial vehicle when the industrial vehicle is supported in the laid-over position on the frame.

In accordance with various aspects of embodiments, a method for transitioning an industrial vehicle from an upright position to a laid-over position is disclosed. The method comprises providing a layover fixture comprising a frame defining a longitudinal direction and a lateral direction transverse to the longitudinal direction, a heal structure coupled to the frame and including a curved surface, and an adjustment mechanism associated with the heal structure. The method further comprises securing the industrial vehicle to the frame while the industrial vehicle is in the upright position, adjusting a position of the heal structure relative to the frame in the longitudinal direction of the frame using the adjustment mechanism, and rotating the frame and the industrial vehicle to transition the industrial vehicle from the upright position to the laid-over position such that the industrial vehicle is supported on a floor surface on the frame. During the rotating, the curved surface of the heal structure grips the floor surface.

The heal structure may be adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame. The adjustment mechanism may be used to adjust the position of the heal structure back to the retracted position once the industrial vehicle is transitioned to the laid-over position.

Adjusting the position of the heal structure relative to the frame may comprise rotating a threaded rod of the adjustment mechanism to effect movement of the heal structure relative to the frame in the longitudinal direction.

The layover fixture may further comprise a second heal structure coupled to the frame and including a curved surface, and a second adjustment mechanism associated with the second heal structure for adjusting the position of the second heal structure relative to the frame in the longitudinal direction. The two heal structures may be respectively coupled to opposed lateral side beams of the frame, and during the rotating, the curved surfaces of both of the heal structures may grip the floor surface.

In accordance with various aspects of embodiments, a method for transitioning an industrial vehicle from a laid-over position to an upright position is disclosed. The method comprises providing a layover fixture comprising a frame defining a longitudinal direction and a lateral direction transverse to the longitudinal direction, wherein the frame supports the industrial vehicle on a floor surface while the industrial vehicle is in the laid-over position, a heal structure coupled to the frame and including a curved surface, and an adjustment mechanism associated with the heal structure. The method further includes adjusting a position of the heal structure relative to the frame in the longitudinal direction of the frame using the adjustment mechanism, and rotating the frame and the industrial vehicle to transition the industrial vehicle from the laid-over position to the upright position, wherein during the rotating, the curved surface of the heal structure grips the floor surface.

The layover fixture may further comprise a second heal structure coupled to the frame and including a curved surface, and a second adjustment mechanism associated with the second heal structure for adjusting the position of the second heal structure relative to the frame in the longitudinal direction. The two heal structures may be adjustable from a retracted position, wherein an inner surface of the two heal structures is adjacent to an edge of a plate structure of the frame, through an extended position, wherein the inner surface of the two heal structures is distal from the edge of the plate structure of the frame in the longitudinal direction of the frame. The two heal structures may be respectively coupled to opposed lateral side beams of the frame, and during the rotating, the curved surfaces of both of the heal structures may grip the floor surface.

Adjusting the position of the two heal structures relative to the frame may comprise rotating a threaded rod of the respective adjustment mechanism to effect movement of the respective heal structure relative to the frame in the longitudinal direction.

### BRIEF DESCRIPTION OF THE DRAWINGS

The embodiments set forth in the drawings are illustrative and not intended to limit the subject matter defined by the claims. The following detailed description of the illustrative embodiments can be understood when read in conjunction with the following drawings, where like structure is indicated with like reference numerals and in which:

FIG. 1A is a perspective view of a first exemplary industrial vehicle supported in a laid-over position on a layover fixture in a first configuration according to embodiments;

FIG. 1B is a perspective view of a second exemplary industrial vehicle supported in a laid-over position on the layover fixture of FIG. 1A in a second configuration according to embodiments;

FIG. 1C is a perspective view of a third exemplary industrial vehicle supported in a laid-over position on the layover fixture of FIG. 1A in a third configuration according to embodiments;

FIG. 2 is a perspective view of the layover fixture;

FIG. 3 is a top plan view of the layover fixture;

FIG. 4A is a side elevation view of a portion of the layover fixture and showing a first adjustment mechanism and a first heal structure in a first position;

FIG. 4B is a side elevation view of the portion of the layover fixture shown in FIG. 4A and showing the first adjustment mechanism and the first heal structure in a second position;

FIG. 5A is a side elevation view of a portion of the layover fixture and showing a second adjustment mechanism and a second heal structure in a first position;

FIG. 5B is a side elevation view of the portion of the layover fixture shown in FIG. 5A and showing the second adjustment mechanism and the second heal structure in a second position;

FIG. 6 is a side elevation view of an exemplary industrial vehicle attached to the layover fixture while the industrial vehicle is in an upright position;

FIG. 7 is a perspective view of the industrial vehicle of FIG. 6 while being transitioned on the layover fixture from an upright position to a laid-over position;

FIG. 8 is a perspective view illustrating multiple layover fixtures stacked on top of one another according to embodiments;

FIG. 9 is a perspective view of a layover fixture according to embodiments;

FIGS. 10A and 10B illustrate a method for transitioning an industrial vehicle between an upright position and a laid-over position using a layover fixture in accordance with embodiments; and

FIGS. 11A and 11B illustrate a method for transitioning an industrial vehicle between a laid-over position and an upright position using a layover fixture in accordance with embodiments.

### DETAILED DESCRIPTION OF EMBODIMENTS

The following text sets forth a broad description of numerous different embodiments of the present disclosure. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. It should be understood that multiple combinations of the embodiments described and shown are contemplated and that a particular focus on one embodiment does not preclude its inclusion in a combination of other described embodiments. Numerous alternative embodiments could also be implemented, using either current technology or technology developed after the filing date of this patent, which would still fall within the scope of the claims. All publications and patents cited herein are incorporated herein by reference.

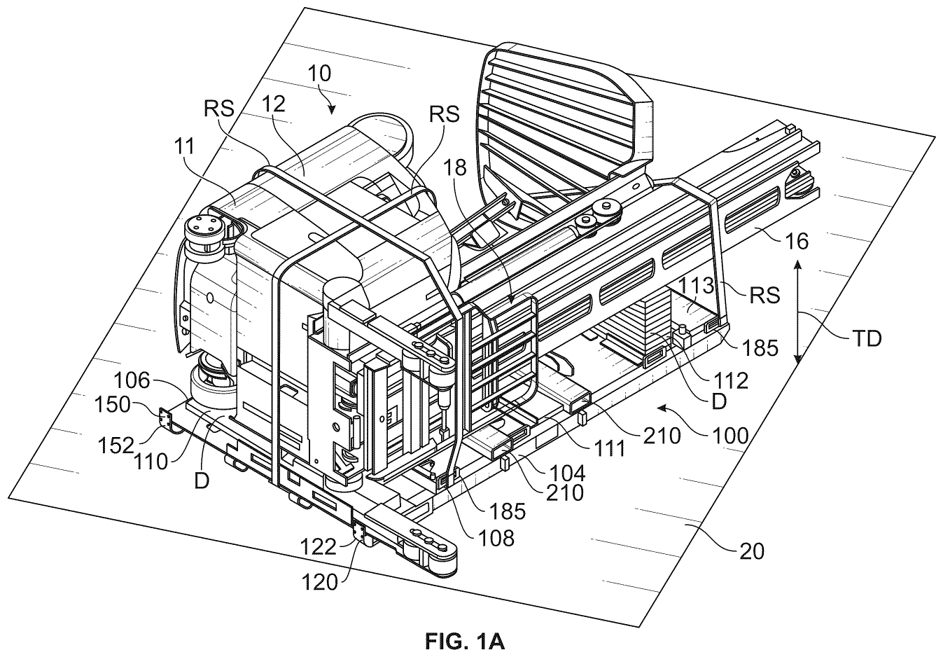

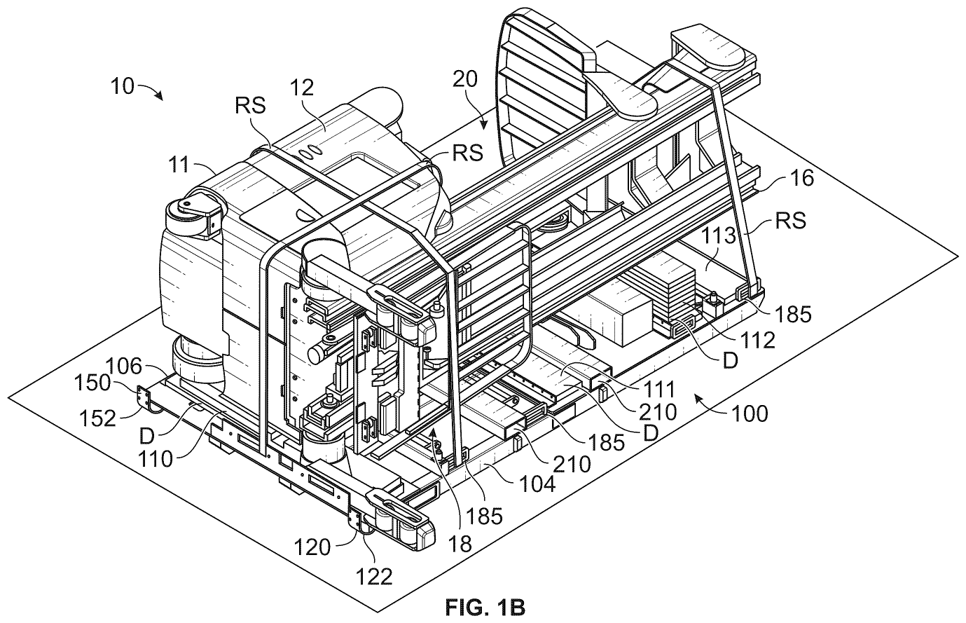

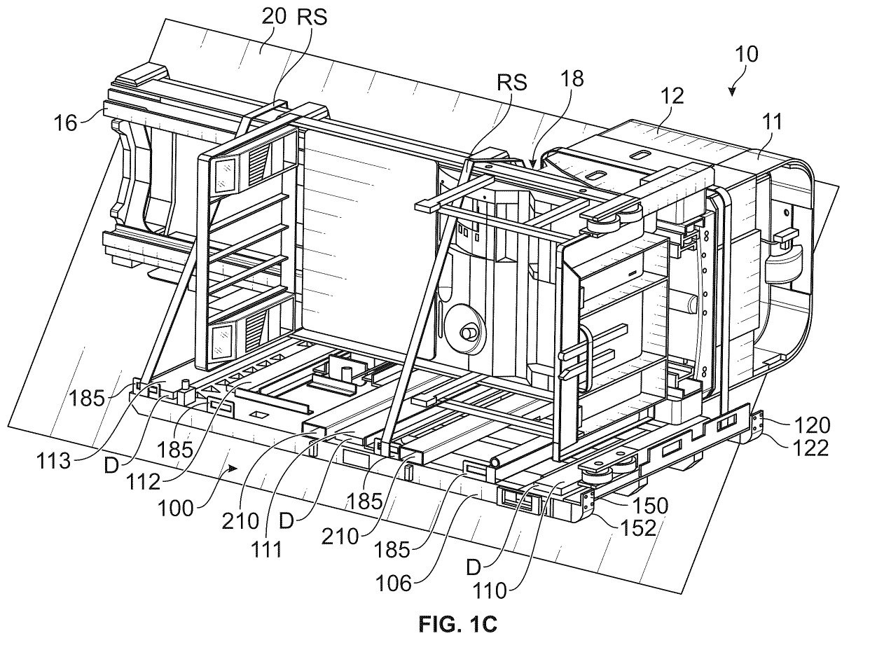

Referring now to the drawings, FIGS. 1A-1C illustrate respective exemplary first, second, and third industrial vehicles 10 supported in horizontal positions on a layover fixture 100 (hereinafter “fixture 100”) constructed in accordance with embodiments. As shown in FIGS. 1A-1C, the fixture 100 is assembled in different configurations to support each particular industrial vehicle 10 in the horizontal position, also referred to herein as a laid-over position. The vehicles 10 depicted in FIGS. 1A-1C are forklift trucks, but the embodiments disclosed herein may be used with any suitable type of industrial vehicle. Embodiments disclosed herein will be discussed with reference to the first exemplary industrial vehicle 10 (hereinafter “vehicle 10”), it being understood that the discussions herein could also pertain to the second and third exemplary industrial vehicles 10 and other suitable types of industrial vehicles suitable for being serviced with the fixture 100.

The vehicle 10 comprises a power unit 12 and a load handling assembly 14 including a mast assembly 16 that supports a carriage assembly 18. The power unit 12, the load handling assembly 14, the mast assembly 16, and the carriage assembly 18 each include conventional components, which will not be described in detail herein.

The vehicle 10 is depicted in FIG. 1A as being completely supported on the fixture 100 in the laid-over position. The fixture 100 may be used to transition the vehicle 10 from an upright position, also referred to herein as a vertical position, to the laid-over position, and vice versa, and also to support the vehicle 10 on a floor surface 20 while the vehicle 10 is in the laid-over position, as will be described in detail herein.

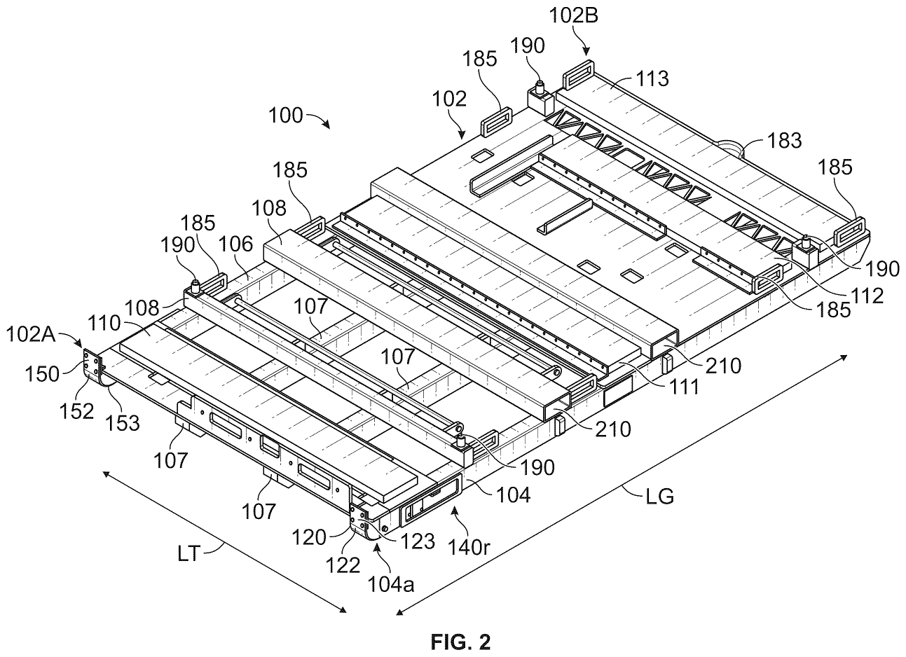

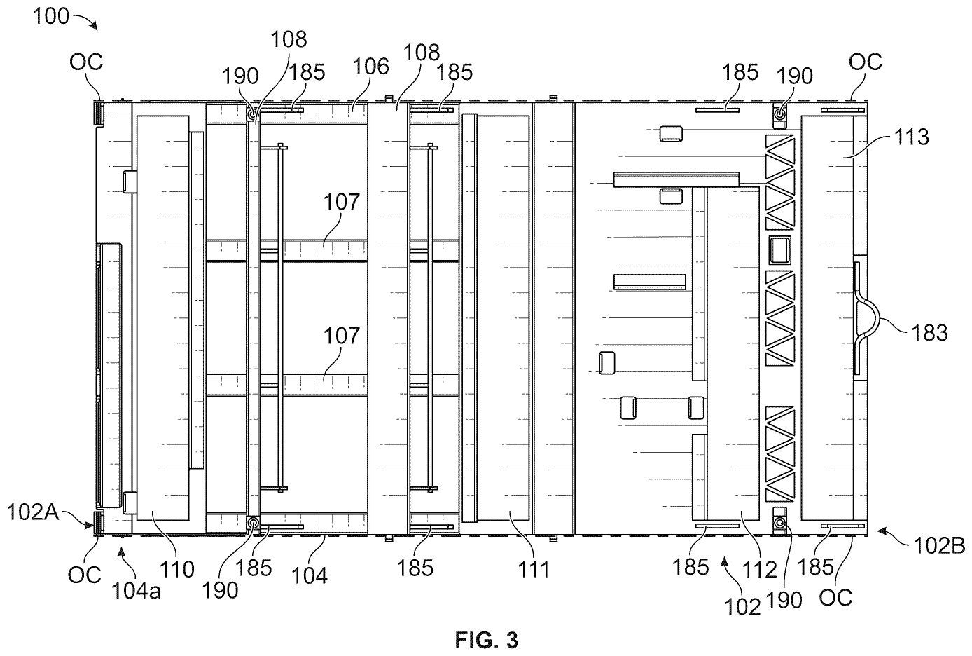

With reference also to FIG. 2, the fixture 100 comprises a frame 102 that provides the support for the vehicle 10 while the vehicle 10 is in the laid-over position and being supported on the floor surface 20 by the fixture 100. The frame 102 defines a longitudinal direction LG and a lateral direction LT transverse to the longitudinal direction LG, and has an outer contour OC in the lateral direction LT, see FIG. 3. The longitudinal direction LG coincides with a direction of elongation of the frame 102. The frame 102 includes a first laterally outer side beam 104 that extends in the longitudinal direction LG from a first end 102A of the frame 102 to a second end 102B of the frame 102, a second laterally outer side beam 106 that extends in the longitudinal direction LG from the first end 102A of the frame 102 to the second end 102B of the frame 102 and is opposed to the first laterally outer side beam 104 in the lateral direction LT. Laterally outermost surfaces of the first and second laterally outer side beams 104, 106 define the bounds of the outer contour OC of the frame 102.

The frame 102 further includes a plurality of inner support beams 107 that extend in the longitudinal direction LG at lateral locations between the first and second laterally outer side beams 104, 106, and a plurality of cross beams 108 that extend in the lateral direction LT between the first and second laterally outer side beams 104, 106. The inner support beams 107 provide support for the cross beams 108, wherein the inner support beams 107 and the cross beams 108 provide stability to the fixture 100. The first and second laterally outer side beams 104, 106, the inner support beams 107, and the cross beams 108 may be formed from metal, such as, for example, hot rolled steel, carbon steel, or any other suitable metal. These beams 104, 106, 107, 108 may all be formed from the same metal or from different metals or metal alloys.

According to embodiments, the fixture 100 may further comprise a plurality of vehicle support portions 110, 111, 112, 113 for contacting and supporting various parts of the vehicle 10 when the vehicle 10 is being transitioned between the upright and laid-over positions and while the vehicle 10 is being supported in the laid-over position by the fixture 100. As shown in FIGS. 1A-1C, the first support portion 110 may support a lower section of a body portion 11 of the vehicle 10, the second support portion 111 may support a lower section of the mast assembly 16, the third support portion 112 may support an intermediate section of the mast assembly 16, and the fourth support portion 113 may support an upper section of the mast assembly 16.

The configuration of these vehicle support portions 110, 111, 112, 113 may vary based on the particular vehicle 10 being supported. In this regard, the vehicle support portions 110, 111, 112, 113 may comprise dunnage D, wherein the amount of dunnage D used to assemble each respective vehicle support portion 110, 111, 112, 113 may vary to adjust the height of the vehicle support portions 110, 111, 112, 113 in a third direction TD (see FIG. 1A), wherein the third direction TD is transverse to the longitudinal direction LG and to the lateral direction LT. The amount of dunnage D used at each vehicle support portion 110, 111, 112, 113 is based upon the type of vehicle 10 being supported on the fixture 100, such that the fixture 100 is customizable to be used with different types of vehicles. To illustrate this, in the exemplary embodiments disclosed in FIGS. 1A-1C, the amount of dunnage D used at the support portions 110, 111, 112, 113 is customized based on the dimensions of the vehicle 10, wherein the second, third, and fourth support portions 111, 112, 113 are each raised from the first support portion 110 in the third direction TD to accommodate the dimensions of the exemplary vehicles 10 being serviced in these figures. According to embodiments, the dunnage D may be formed from a variety of suitable materials, such as, for example, wood or recycled plastic. It is conceived that after a position transfer service or supporting service of a vehicle 10 using the fixture 100 is complete and the vehicle 10 is removed from the fixture 100, the dunnage D may be reused on the fixture 100 to service another vehicle 10, or the dunnage D may be recycled.

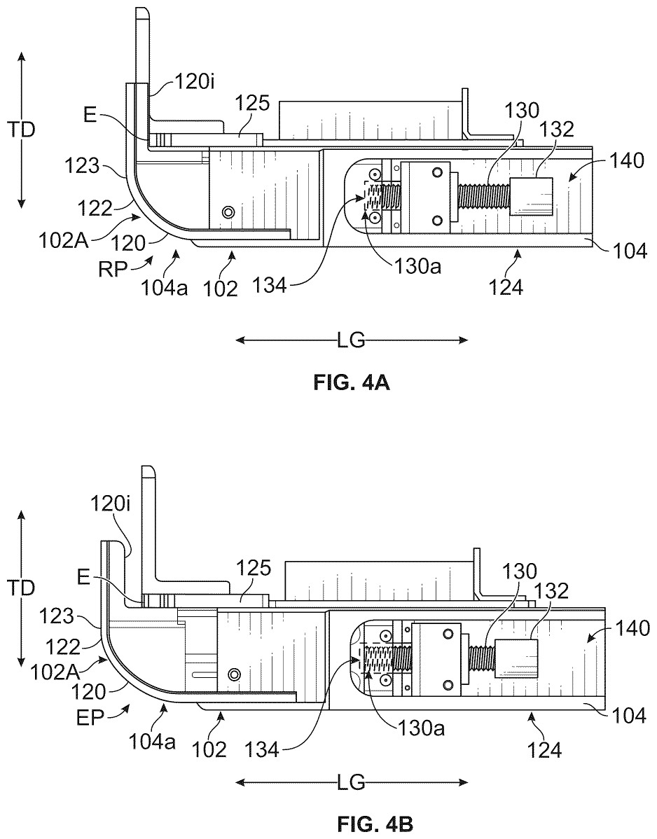

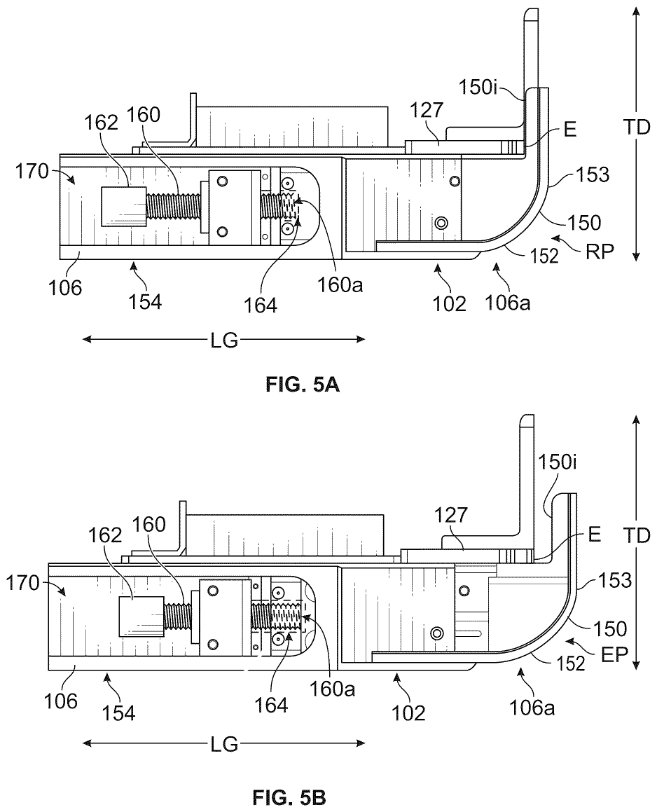

With reference now to FIGS. 4A and 4B, the fixture 100 further comprises a first heal structure 120 (hereinafter “heal structure 120”) that is coupled to the frame 102 at the first end 102A, e.g., to an end portion 104a of the first laterally outer side beam 104, see also FIG. 2. The heal structure 120 includes a curved outer surface 122 that faces away from the vehicle 10 when the vehicle 10 is supported on the frame 102 and is used for gripping the floor surface 20 while the fixture 100 is being used to transition the vehicle 10 between the upright and laid-over positions, as will be described in detail herein. According to embodiments, the curved outer surface 122 may include an insert 123 to militate against unwanted sliding or skidding movement of the fixture 100 when the fixture 100 is being used to transition the vehicle 10 between the upright and the laid-over positions. The insert 123 may be separately formed from the heal structure 120 and applied thereto, in which case the insert 123 may be formed, for example, from rubber. Alternatively, the insert 123 may be integrally formed with the heal structure 120, such as, for example, where the insert 123 is formed as a series of corrugations or protuberances in the curved outer surface 122.

As shown in FIGS. 4A and 4B, a first adjustment mechanism 124 (hereinafter “adjustment mechanism 124”) is associated with the heal structure 120 for adjusting a position of the heal structure 120 relative to the frame 102 in the longitudinal direction LG of the frame 102. According to embodiments, the adjustment mechanism 124 comprises a threaded rod 130 that is coupled to the heal structure 120 and an adjustment portion 132 for rotating the threaded rod 130, wherein rotation of the threaded rod 130 effects an adjustment to the position of the heal structure 120 relative to the frame 102 in the longitudinal direction LG of the frame 102. Specifically, rotation of the threaded rod 130 in a first direction effects movement of the heal structure 120 away from the first end 102A of the frame 102, and rotation of the threaded rod 130 in a second direction opposite to the first direction effects movement of the heal structure 120 toward the first end 102A of the frame 102. The heal structure 120 may include a recess 134, which may comprise a threaded recess, for receiving an end portion 130a of the threaded rod 130 of the adjustment mechanism 124.

The heal structure 120 is adjustable from a retracted position RP, see FIG. 4A, wherein an inner surface 120i of the heal structure 120 is located adjacent to an edge E of a first plate structure 125 of the frame 102, through an extended position EP, see FIG. 4B, wherein the inner surface 120i of the heal structure 120 is located distal from the edge E of the first plate structure 125 of the frame 102 in the longitudinal direction LG of the frame 102. The first plate structure 125 extends along the top of the frame 102 in the lateral direction LT. When the heal structure 120 is in the retracted position RP, a portion of the inner surface 120i of the heal structure 120 is positioned adjacent to a portion of the edge E of the first plate structure 125 such that the inner surface 120i and the edge E of the first plate structure 125 make surface contact or come into close proximity to one another. The heal structure 120 may be adjusted to any position between and including the retracted position RP and the extended position EP.

According to embodiments, the adjustment mechanism 124 may be completely positioned within a first recess 140 located in the first laterally outer side beam 104 of the frame 102, such that the adjustment mechanism 124 does not protrude beyond the outer contour OC of the frame 102. Hence, damage to the adjustment mechanism 124, e.g., caused by contact with an external object, may be reduced or avoided.

According to the exemplary embodiments of FIGS. 1A-1C, the fixture 100 may further comprise a second heal structure 150 (hereinafter “heal structure 150”) coupled to the opposed lateral side of the frame 102 from the first heal structure 120, and a second adjustment mechanism 154 (hereinafter “adjustment mechanism 154”) associated with the heal structure 150. The heal structure 150 and adjustment mechanism 154 may be similar to and function the same as the first heal structure 120 and first adjustment mechanism 124, and may be coupled to the frame 102 at the first end 102A, e.g., to an end portion 106a of the second laterally outer side beam 106, see FIG. 2.

The second heal structure 150 includes a curved outer surface 152 that faces away from the vehicle 10 when the vehicle 10 is supported on the frame 102 and is used for gripping the floor surface 20 while the fixture 100 is being used to transition the vehicle 10 between the upright and the laid-over positions, as will be described in detail herein. According to embodiments, the curved outer surface 152 may include an insert 153 to militate against unwanted sliding or skidding movement of the fixture 100 when the fixture 100 is being used to transition the vehicle 10 between the upright and laid-over positions. The insert 153 may be separately formed from the heal structure 150 and applied thereto, in which case the insert 153 may be formed, for example, from rubber. Alternatively, the insert 153 may be integrally formed with the heal structure 150, such as, for example, where the insert 153 is formed as a series of corrugations or protuberances in the curved outer surface 152.

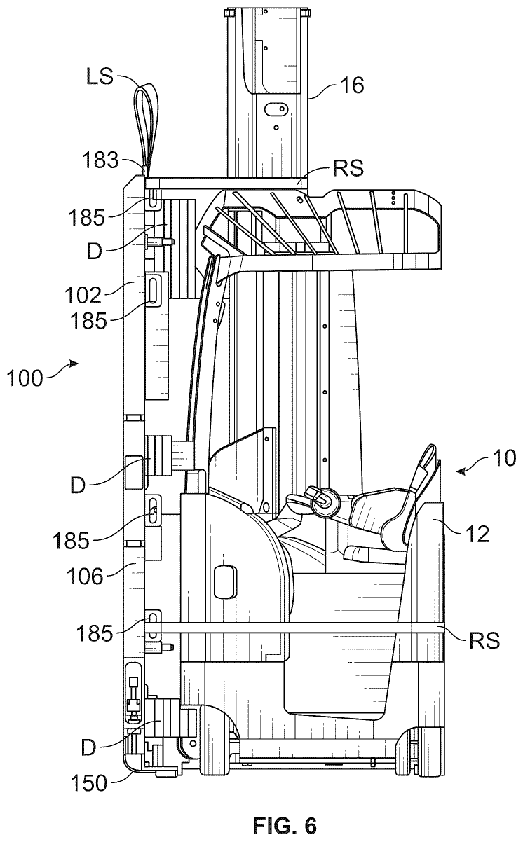

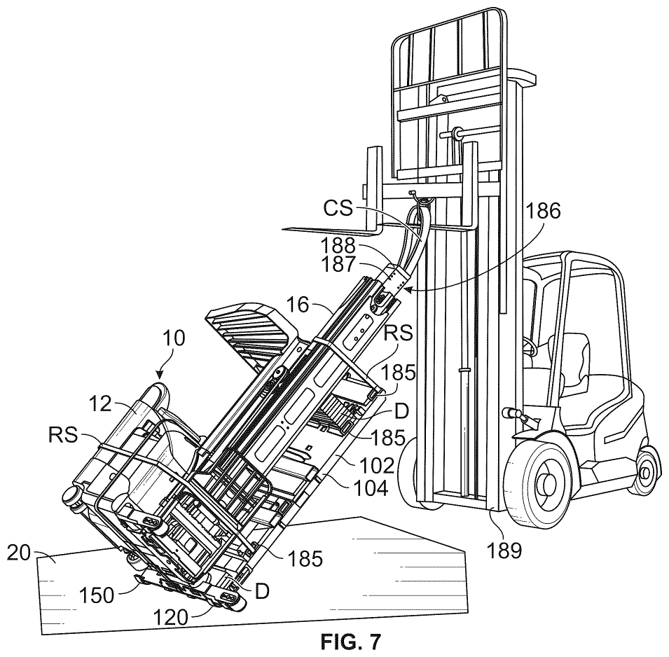

As shown in FIGS. 5A and 5B, the adjustment mechanism 154 is provided for adjusting a position of the heal structure 150 relative to the frame 102 in the longitudinal direction LG of the frame 102. According to embodiments, the adjustment mechanism 154 comprises a threaded rod 160 that is coupled to the heal structure 150 and an adjustment portion 162 for rotating the threaded rod 160, wherein rotation of the threaded rod 160 effects an adjustment to the position of the heal structure 150 relative to the frame 102 in the longitudinal direction LG of the frame 102. Specifically, rotation of the threaded rod 160 in a first direction effects movement of the heal structure 150 away from the first end 102A of the frame 102, and rotation of the threaded rod 160 in a second direction opposite to the first direction effects movement of the heal structure 150 toward the first end 102A of the frame 102. The heal structure 150 may include a recess 164, which may comprise a threaded recess, for receiving an end portion 160a of the threaded rod 160 of the adjustment mechanism 154.

The heal structure 150 is adjustable from a retracted position RP, see FIG. 5A, wherein an inner surface 150i of the heal structure 150 is adjacent to an edge E of a second plate structure 127 of the frame 102, through an extended position EP, see FIG. 5B, wherein the inner surface 150i of the second heal structure 150 is distal from the edge E of the second plate structure 127 of the frame 102 in the longitudinal direction LG of the frame 102. The second plate structure 127 extends along the top of the frame 102 in the lateral direction LT. When the second heal structure 150 is in the retracted position RP, a portion of the inner surface 150i of the second heal structure 150 is positioned adjacent to a portion of the edge E of the second plate structure 127 such that the inner surface 150i and the edge E of the second plate structure 127 make surface contact or come into close proximity to one another. The second heal structure 150 may be adjusted to any position between and including the retracted position RP and the extended position EP. It is contemplated that the first and second plate structures 125, 127 could be formed as a single plate structure that spans across the frame 102 in the later direction LT.

According to embodiments, the adjustment mechanism 154 may be completely positioned within a second recess 170 located in the second laterally outer side beam 106 of the frame 102, such that the adjustment mechanism 154 does not protrude beyond the outer contour OC of the frame 102. Hence, damage to the adjustment mechanism 164, e.g., caused by contact with an external object, may be reduced or avoided.

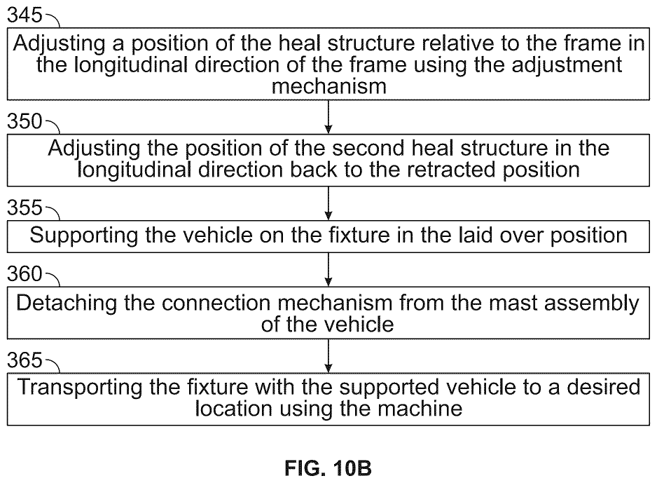

The two heal structures 120, 150 are adjustable in the longitudinal direction LG of the frame 102 independently of each other via the respective adjustment mechanisms 124, 154, such that adjustment of the two heal structures 120, 150 allows for maximized control by a technician. By way of example and not limitation, the two heal structures 120, 150 may be adjusted to two different lengths to account for any number of factors, such as variations in one or more of: the floor surface 20, frame dimensions (e.g., in case the frame may have been deformed), etc. It is noted that the size, location, and/or shape of the heal structures 120, 150 could vary from those shown, such as, for example, in the embodiment disclosed in FIG. 9, which will be described below.

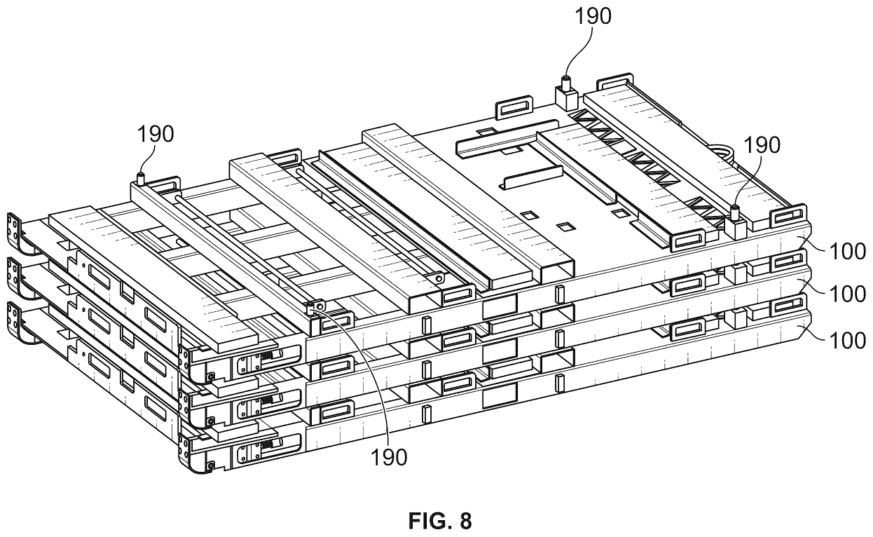

Referring now to FIG. 6, the fixture 100 according to embodiments may further include an attachment structure, such as a hook 183, which may be used to receive a lifting strap LS to lift the fixture 100 up from the floor surface 20 to the vehicle 10 when the vehicle 10 is in the upright position, so that the fixture 100 may be secured to the vehicle 10 in preparation for transitioning the vehicle 10 from an upright position to a laid-over position. The lifting strap LS may be supported, for example, by a machine (not shown in this embodiment), such as a second industrial vehicle or crane, which is used to lift the lifting strap LS and the attached fixture 100 and to position the fixture 100 adjacent to the vehicle 10. When the fixture 100 is in the proper position, the technician may proceed to secure the fixture 100 to the vehicle 10, such as by using one or more ratchet straps RS. In this regard, the frame 102 may include a plurality of ratchet strap fasteners 185 that receive and serve as connection points for the ratchet straps RS.

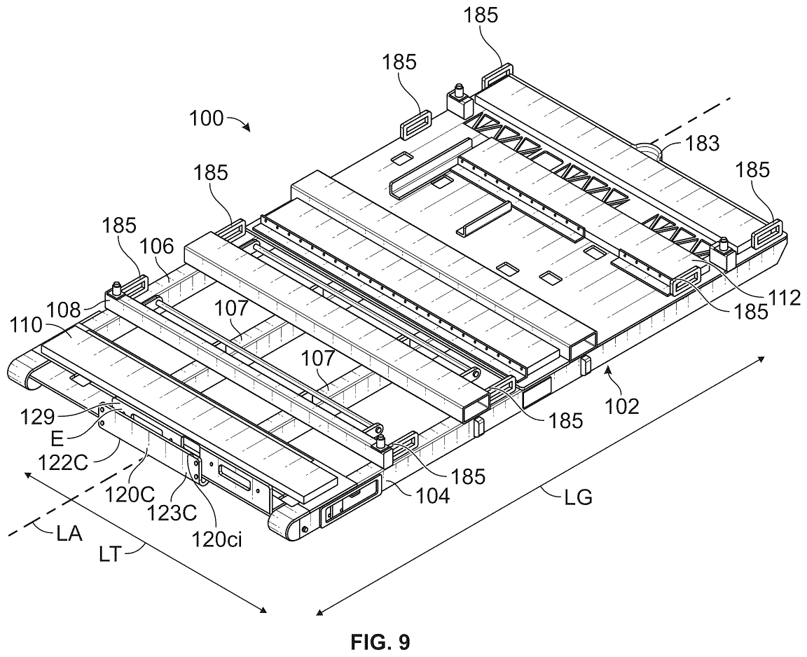

With reference to FIG. 7, to facilitate the transition of the vehicle 10 from the upright position to the laid-over position, a connection mechanism 186 according to embodiments may be temporarily connected to the mast assembly 16. The connection mechanism 186 comprises a main body portion 187 that is removably attached to the mast assembly 16, and a receiving portion 188 for receiving a connection strap CS. The connection mechanism 186 is coupled to and actuated by a machine 189, such as a crane, another industrial vehicle, etc., which may be the same machine or a different machine that is used in connection with the attachment structure as described above with reference to FIG. 6, to facilitate transitioning the vehicle 10 between the upright position and the laid-over position and vice versa, as will be described in detail herein.

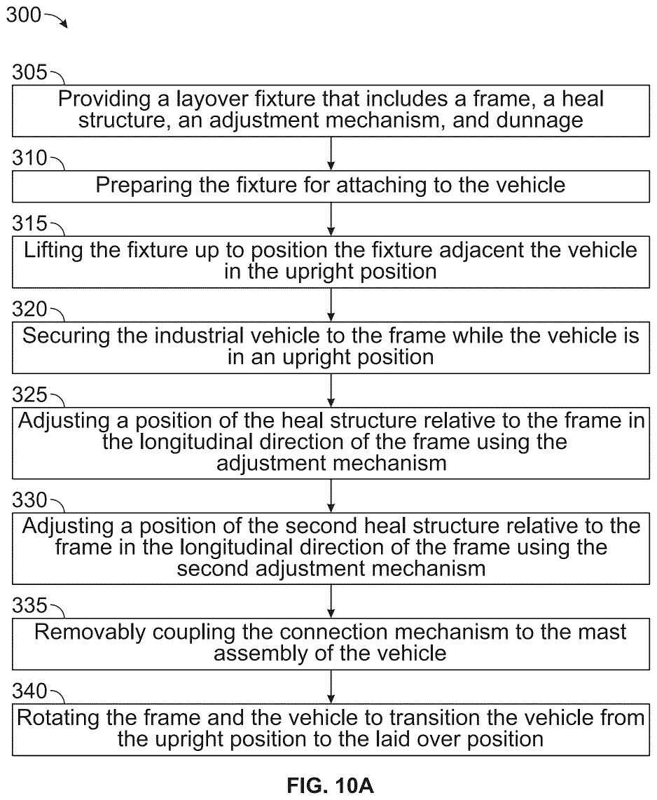

According to embodiments, the fixture 100 may further include a plurality of stacking caps 190 (most clearly shown in FIGS. 2, 3, and 8) for stacking an additional layover fixture on top of the fixture 100 when the fixture 100 is being stowed and not being used to support a vehicle thereon. Each of the plurality of stacking caps 190 may be spaced apart from each other on the fixture 100 so as to evenly support the additional layover fixture. In the exemplary embodiment as most clearly shown in FIGS. 2 and 3, four stacking caps 190 are provided, wherein a first pair of the stacking caps 190 is spaced from one another in the longitudinal directions LG and positioned on the first laterally outer side beam 104, and a second pair of stacking caps 190 is spaced from one another in the longitudinal directions LG and positioned on the second laterally outer side beam 106. The first and second pairs of stacking caps 190 are spaced apart from each other in the lateral direction LT, such that the stacking caps 109 in the exemplary embodiment shown are arranged in a rectangular configuration, although it is contemplated that additional stacking caps and/or different arrangements of the stacking caps 190 may be used. The stacking caps 190 may be integrally formed with the fixture 100, or may be separately formed and secured to the fixture 100, such as by welding. Additional layover fixtures 100 may be stacked on top of each other as discussed in detail herein, see FIG. 8. The stacked configuration for a plurality of fixtures 100 provided by the stacking caps 190 provides space saving benefits when moving/transporting multiple fixtures 100 and also while the fixtures 100 are being stowed when not in use.

Referring now to FIG. 9, according to another exemplary embodiment, the heal structure may comprise a single heal structure 120c that is generally centered along a lateral axis LA of the fixture 100 that extends in the longitudinal direction LG of the frame 102. The heal structure 120c may be coupled to one or more of the inner support beams 107 and/or cross beams 108 of the frame 102, and includes a curved outer surface 122c that faces away from a vehicle 10 when the vehicle 10 is supported on the frame 102 and is used for gripping the floor surface 20 while the fixture 100 is being used to transition the vehicle 10 between the upright and laid-over positions. The outer curved surface 112c may include an insert 123c to militate against unwanted sliding or skidding movement of the fixture 100 when the fixture 100 is being used to transition the vehicle 10 between the upright and laid-over positions.

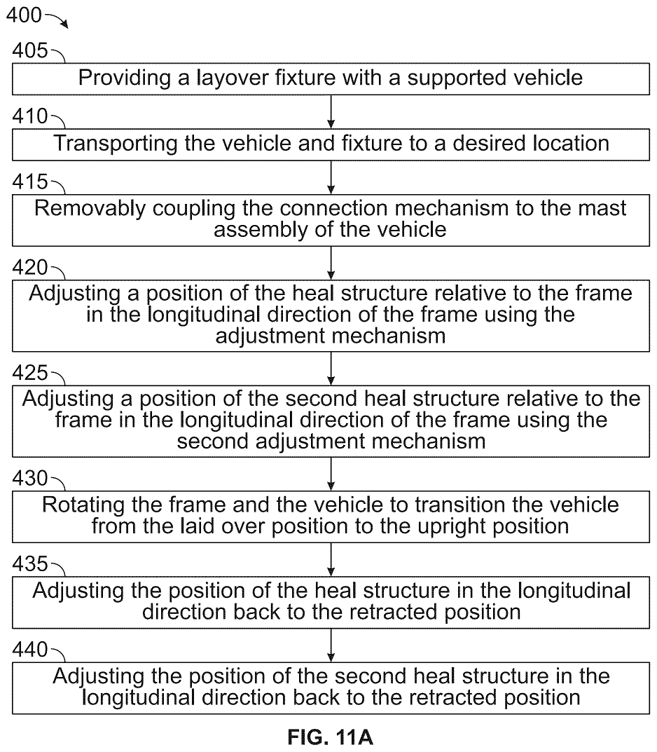

An adjustment mechanism (not specifically shown in this embodiment) may be associated with the heal structure 120c for adjusting a position of the heal structure 120c relative to the frame 102 in the longitudinal direction LG of the frame 102. The adjustment mechanism may include the same components and function in the same way as the adjustment mechanisms 124, 154 described herein with reference to FIGS. 4A-5B, wherein the recess of the frame 102 that receives the adjustment mechanism may be located in one of the inner support beams 107. As with the embodiment described above, the heal structure 120c is adjustable from a retracted position, wherein an inner surface 120ci of the heal structure 120c is located adjacent to an edge E of a plate structure 129 of the frame 102, through an extended position, wherein the inner surface 120ci of the heal structure 120c is located distal from the edge E of the plate structure 129 of the frame 102 in the longitudinal direction LG of the frame 102. The plate structure 129 extends along the top of the frame 102 in the lateral direction LT. The heal structure 120c may be adjusted to any position between and including the retracted position and the extended position. It is noted that the size and shape of the heal structure 120c could vary from that shown. With reference now to FIGS. 10A, 10B, an exemplary method 300 for transitioning an industrial vehicle from an upright position to a laid-over position using a layover fixture in accordance with embodiments will now be described. The method 300 will be described with reference to the vehicle 10 and the fixture 100 as discussed above. Unless mentioned otherwise, the order of the steps provided for the method below is exemplary, i.e., the steps of the disclosed method do not need to be completed in the order provided unless the step indicates that it is to be completed before or after another step.

As an initial step, components of the vehicle 10 may be prepared for being transitioned from the upright position to the laid-over position. This preparation may include, for example, attaching straps around various vehicle components, such as, for example an operator platform and outriggers, the power unit 12, the battery cover, etc. Additionally, the fixture 100 may be configured to support the particular vehicle 10 being serviced, including adding the appropriate dunnage D to securely support the vehicle components, which could be done at any time prior to securing the vehicle 10 to the fixture 100.

At step 305, the fixture 100 is provided, the fixture 100 comprising the frame 102, the heal structure 120, the adjustment mechanism 124, and the appropriate dunnage D. At step 310, the fixture 100 is prepared for attachment to the vehicle 10, which may include removably attaching the lifting strap LS to the hook 183 of the frame 102, and utilizing the machine to receive lifting strap LS.

At step 315, the fixture 100 is lifted using the machine and the lifting strap LS. Once the fixture 100 is positioned properly with respect to the vehicle 10 while in the upright position, i.e., such that the vehicle support portions 110, 111, 112, 113 are aligned with the appropriate parts of the vehicle 10, at step 320, the vehicle 10 is secured to the frame 102 of the fixture 100, such as by using the one or more ratchet straps RS, as shown in FIG. 6. The securing process is tailored depending on the type of vehicle 10 being serviced. For example, based on the type of vehicle being serviced, the number of ratchet straps RS used may vary, the number and location of securing locations on the frame 102 may vary, and the location and amount of dunnage D used may be different. Once the fixture 100 is secured to the vehicle 10, the lifting strap LS may be removed from the hook 183 of the frame 102.

At step 325, the position of the first heal structure 120 is adjusted relative to the frame 102 in the longitudinal direction LG of the frame 102 using the first adjustment mechanism 124. The first heal structure 120 is adjustable from the retracted position RP to the extended position EP, see FIGS. 4A, 4B. Adjusting the position of the first heal structure 120 relative to the frame 102 may comprise rotating the threaded rod 130 of the first adjustment mechanism 124 to effect movement of the first heal structure 120 relative to the frame 102 in the longitudinal direction LG.

At step 330, the position of the second heal structure 150 is adjusted relative to the frame 102 in the longitudinal direction LG of the frame 102 using the second adjustment mechanism 154. The second heal structure 150 is adjustable from the retracted position RP to the extended position EP, see FIGS. 5A, 5B. Adjusting the position of the second heal structure 150 relative to the frame 102 may comprise rotating the threaded rod 160 of the second adjustment mechanism 154 to effect movement of the second heal structure 150 relative to the frame 102 in the longitudinal direction LG.

At step 335, the connection mechanism 186 is removably coupled to the mast assembly 16 of the vehicle 10. At step 340, the connection mechanism 186 is actuated to initiate rotation of the fixture 100 and the supported vehicle 10 relative to the floor surface 20. Actuating the connection mechanism 186 may be effected by using the machine 189 to rotate the connection mechanism 186, thus transitioning the vehicle 10, with the fixture 100 coupled thereto, from the upright position to the laid-over position at step 340, see FIG. 7. While the vehicle 10 is transitioned from the upright position to the laid-over position, the curved outer surfaces 122, 152 of the heal structures 120, 150, rotate along the floor surface 20, wherein the inserts 123, 153 grip the floor surface 20 to militate against unwanted slippage. The fixture 100 and the vehicle 10 are rotated to transition the vehicle 10 from the upright position to the laid-over position such that the vehicle 10 is supported on the floor surface 20 entirely on the frame 102 of the fixture 100.

At step 345, the position of the first heal structure 120 may optionally be adjusted in the longitudinal direction LG of the frame 102 using the first adjustment mechanism 124. The first heal structure 120 may be returned to the retracted position RP once the vehicle 10 is transitioned to the laid-over position, or alternatively, may be adjusted to any desired position between the extended position EP and the retracted position RP. It is noted that the first heal structure 120 may be left in the extended position EP for a subsequent transition of the vehicle 10 from the laid-over position to the upright position as will be described below.

At step 350, the position of the second heal structure 150 may optionally be adjusted in the longitudinal direction LG of the frame 102 using the adjustment mechanism 154. The second heal structure 150 may be returned to the retracted position RP once the vehicle 10 is transitioned to the laid-over position, or alternatively, may be adjusted to any desired position between the extended position EP and the retracted position RP. It is noted that the second heal structure 150 may be left in the extended position EP for a subsequent transition of the vehicle 10 from the laid-over position to the upright position as will be described below.

At step 355, the fixture 100 completely supports the vehicle 10 on the floor surface 20 in the laid-over position, as shown in FIG. 1. At step 360, the connection mechanism 186 is optionally detached from the mast assembly 16 of the vehicle 10, although it is noted that the connection mechanism 186 may remain attached to the vehicle 10 during transport of the vehicle 10 so that it can be used again to transition the vehicle from the laid-over position to the upright position as will be described below. At step 365, the fixture 100 with the supported vehicle 10 may be transported to a desired location using a transporting vehicle (not shown), such as another industrial vehicle. To this end, the forks of the transporting vehicle may be inserted into fork pockets 210 (see FIG. 2) of the fixture 100, wherein the transporting vehicle would then lift the fixture 100 with the vehicle 10 supported thereon to transport the vehicle 10 to the desired location.

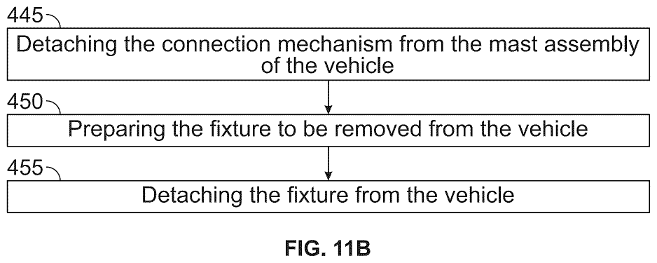

Referring now to FIGS. 11A and 11B, an exemplary method 400 for transitioning an industrial vehicle between a laid-over position and an upright position using a fixture in accordance with embodiments will now be described. The method 400 will be described with reference to the vehicle 10 and the fixture 100 as discussed above. Unless mentioned otherwise, the order of the steps provided for the method below is exemplary, i.e., the steps of the disclosed method do not need to be completed in the order provided unless the step indicates that it is to be completed before or after another step.

At step 405, the fixture 100 with the supported vehicle 10 is provided, and at step 410, the fixture 100 and the supported vehicle 10 are transported to a desired location. At step 415, if not previously performed, the connection mechanism 186 is removably attached to the mast assembly 16 of the vehicle 10.

At step 420, the position of the first heal structure 120 is adjusted relative to the frame 102 in the longitudinal direction LG of the frame 102 to the extended position EP using the adjustment mechanism 124. Adjusting the position of the first heal structure 120 relative to the frame 102 may comprise rotating the threaded rod 130 of the adjustment mechanism 124 to effect movement of the heal structure 120 relative to the frame 102 in the longitudinal direction LG.

At step 425, the position of the second heal structure 150 is adjusted relative to the frame 102 in the longitudinal direction LG of the frame 102 to the extended position EP using the second adjustment mechanism 154. Adjusting the position of the second heal structure 150 relative to the frame 102 may comprise rotating the threaded rod 160 of the second adjustment mechanism 154 to effect movement of the second heal structure 150 relative to the frame 102 in the longitudinal direction LG.

It is noted that steps 420 and/or 425 may be completed at any suitable time, including prior to step 405, such as during the method 300 for transitioning the vehicle 10 from an upright position to a laid-over position as described above, e.g., at steps 325 and/or 330. That is the first and/or second heal structures 120, 150 could be left in the extended position EP after steps 325 and/or 330 of method 300 are completed, i.e., steps 345 and 350 of the method 300 are optional as noted above and could be skipped, with the first and/or second heal structures 120, 150 being left in the extended positions EP at that point.

At step 430, the connection mechanism 186 is actuated to rotate the vehicle 10 and the fixture 100 relative to the floor surface 20. Actuating the connection mechanism 186 may be effected by using a machine 189 to rotate the connection mechanism 186, thus transitioning the vehicle 10, with the fixture 100 coupled thereto, from the laid-over position to the upright position at step 430. While the vehicle 10 is transitioned from the upright position to the laid-over position, the curved surfaces 122, 152 of the heal structures 120, 150 rotate along the floor surface 20, wherein the inserts 123, 153 grip the floor surface 20 to militate against unwanted slippage. The fixture 100 and the vehicle 10 are rotated to transition the vehicle 10 from the laid-over position to the upright position such that the vehicle 10 is no longer supported on the floor surface 20 by the frame 102, but instead stands itself on the floor surface 20.

At step 435, the position of the first heal structure 120 may be adjusted in the longitudinal direction LG of the frame 102 using the adjustment mechanism 124. The first heal structure 120 may be returned to the retracted position RP, or alternatively, may be adjusted to any position between the extended position EP and the retracted position RP.

At step 440, the position of the second heal structure 150 may be adjusted in the longitudinal direction LG of the frame 102 using the second adjustment mechanism 154. The second heal structure 150 may be returned to the retracted position RP, or alternatively, may be adjusted to any position between the extended position EP and the retracted position RP.

At step 445, the connection mechanism 186 may be detached from the mast assembly 16 of the vehicle 10. At step 450, the fixture 100 may be prepared to be removed from the vehicle 10, which may include attaching the lifting strap LS to the hook 183 on the frame 102, and utilizing a machine to receive the lifting strap LS such that the fixture 100 is supported by the machine. Any ratchet straps used to attach the fixture 100 to the vehicle 10 may be removed, as well as any dunnage D used to support the vehicle 10 on the fixture 100. This process is tailored depending on the type of vehicle 10 being serviced. For example, based on the type of vehicle being serviced, the number of ratchet straps RS used may vary, the number and location of securing locations on the frame 102 may vary, and the location and amount of dunnage D used may be different.

At step 460, the fixture 100 may be removed from the vehicle 10 and transported to another location, for example, in preparation to use the fixture 100 to service another vehicle or to stow the fixture 100 until further use.

Representative embodiments of the present disclosure described above can be described as follows:
A. A layover fixture for transitioning an industrial vehicle between an upright position and a laid-over position comprising:
   a frame that supports the industrial vehicle in the laid-over position on a floor surface, the frame defining a longitudinal direction and a lateral direction transverse to the longitudinal direction;
   a heal structure coupled to the frame and including a curved surface for gripping the floor surface while the layover fixture is being used to transition the industrial vehicle between the upright position and the laid-over position; and
   an adjustment mechanism associated with the heal structure, the adjustment mechanism for adjusting a position of the heal structure relative to the frame in the longitudinal direction of the frame.
B. The layover fixture of clause A, wherein the adjustment mechanism comprises a threaded rod coupled to the heal structure and an adjustment portion for rotating the threaded rod to adjust the position of the heal structure relative to the frame in the longitudinal direction of the frame.
C. The layover fixture of clause B, wherein the heal structure includes a recess for receiving an end portion of the threaded rod of the adjustment mechanism.
D. The layover fixture of any of clauses A-C, wherein the adjustment mechanism is positioned within a recess of the frame such that the adjustment mechanism does not protrude beyond the outer contour of the frame.
E. The layover fixture of any of clauses A-D, wherein the layover fixture further comprises a second heal structure coupled to the frame, the second heal structure including a curved surface for gripping the floor surface while the layover fixture is being used to transition the industrial vehicle between an upright position and a laid-over position.
F. The layover fixture of clause E, wherein the two heal structures are respectively coupled to opposed lateral sides of the frame.
G. The layover fixture of clause E or F, further comprising a second adjustment mechanism associated with the second heal structure, the second adjustment mechanism for adjusting a position of the second heal structure relative to the frame in the longitudinal direction of the frame.
H. The layover fixture of any of clauses E-G, wherein the two adjustment mechanisms are positioned within recesses provided in respective laterally outer first and second side beams of the frame such that the two adjustment mechanisms do not protrude beyond the outer contour of the frame.
I. The layover fixture of clause G or H, wherein the two heal structures are adjustable in the longitudinal direction of the frame independently of each other via the respective adjustment mechanisms.
J. The layover fixture of any of clauses A-I, wherein the curved outer surface of the heal structure comprises an insert for gripping the floor surface while the layover fixture is being used to transition the industrial vehicle between an upright position and a laid-over position.
K. The layover fixture of any of clauses A-J, wherein the heal structure is adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame.
L. The layover fixture of any of clauses A-K, wherein the frame comprises:
   a first laterally outer side beam extending in the longitudinal direction;
   a second laterally outer side beam extending in the longitudinal direction and opposed from the first laterally outer side beam in the lateral direction; and
   a plurality of cross beams extending in the lateral direction between the first and second laterally outer side beams.
M. The layover fixture of clause L, further comprising:
   a first support portion that supports a body portion of the industrial vehicle; and
   a second support portion that supports a mast assembly of the industrial vehicle, the second support portion raised from the first support portion in a third direction that is transverse to the longitudinal direction and to the lateral direction.
N. The layover fixture of clause L or M, wherein the first and second laterally outer side beams and the cross beams are formed from metal.
O. The layover fixture of any of clauses L-N, wherein the heal structure is coupled to an end portion of the first laterally outer side beam of the frame, and the adjustment mechanism is positioned within a recess of the first laterally outer side beam.
P. The layover fixture of any of clauses L-O, wherein the layover fixture further comprises:
   a second heal structure coupled to an end portion of the second laterally outer side beam of the frame, the second heal structure including a curved surface for gripping the floor surface while the layover fixture is being used to transition the industrial vehicle between an upright position and a laid-over position; and
   a second adjustment mechanism associated with the second heal structure, the second adjustment mechanism for adjusting a position of the second heal structure relative to the frame in the longitudinal direction of the frame, wherein the second adjustment mechanism is positioned within a recess of the second laterally outer side beam.
Q. The layover fixture of any of clauses A-P, wherein the heal structure is generally centered along a lateral axis of the frame that extends in the lateral direction of the frame.
R. The layover fixture of any of clauses A-Q, further comprising a plurality of stacking caps for stacking a second layover fixture on top of the layover fixture when the layover fixture is not being used to support an industrial vehicle.
S. The layover fixture of any of clauses A-R, wherein the frame includes a pair of fork pockets for receiving forks of a transporting vehicle that is used to move the layover fixture from a first location to a second location.
T. The layover fixture of any of clauses A-S, further comprising one or more support areas on the frame for receiving dunnage for supporting portions of the industrial vehicle when the industrial vehicle is supported in the laid-over position on the frame.
U. The layover fixture of clause T, wherein the dunnage is formed from wood.
V. The layover fixture of any of clauses A-U, further comprising an accessory support structure for securing spare parts or accessories associated with the industrial vehicle to the layover fixture.
W. A method for transitioning an industrial vehicle from an upright position to a laid-over position comprising:
   providing a layover fixture comprising:
      a frame defining a longitudinal direction and a lateral direction transverse to the longitudinal direction;
      a heal structure coupled to the frame and including a curved surface; and
      an adjustment mechanism associated with the heal structure;
   securing the industrial vehicle to the frame while the industrial vehicle is in the upright position;
   adjusting a position of the heal structure relative to the frame in the longitudinal direction of the frame using the adjustment mechanism; and
   rotating the frame and the industrial vehicle to transition the industrial vehicle from the upright position to the laid-over position such that the industrial vehicle is supported on a floor surface on the frame, wherein during the rotating, the curved surface of the heal structure grips the floor surface.
X. The method of clause W, wherein the heal structure is adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame.
Y. The method of clause X, further comprising using the adjustment mechanism to adjust the position of the heal structure back to the retracted position once the industrial vehicle is transitioned to the laid-over position.
Z. The method of any of clauses W-Y, wherein adjusting the position of the heal structure relative to the frame comprises rotating a threaded rod of the adjustment mechanism to effect movement of the heal structure relative to the frame in the longitudinal direction.
AA. The method of any of clauses W-Z, wherein the layover fixture further comprises:
   a second heal structure coupled to the frame and including a curved surface; and
   a second adjustment mechanism associated with the second heal structure for adjusting the position of the second heal structure relative to the frame in the longitudinal direction;
   wherein the two heal structures are respectively coupled to opposed lateral side beams of the frame.
BB. The method of clause AA, wherein during the rotating, the curved surfaces of both of the heal structures grip the floor surface.
CC. The method of any of clauses W-BB, wherein securing the industrial vehicle to the frame comprises securing the industrial vehicle to the frame with a plurality of straps.
DD. A method for transitioning an industrial vehicle from a laid-over position to an upright position comprising:
   providing a layover fixture comprising:
      a frame defining a longitudinal direction and a lateral direction transverse to the longitudinal direction, wherein the frame supports the industrial vehicle on a floor surface while the industrial vehicle is in the laid-over position;
      a heal structure coupled to the frame and including a curved surface; and
      an adjustment mechanism associated with the heal structure;
   adjusting a position of the heal structure relative to the frame in the longitudinal direction of the frame using the adjustment mechanism; and
   rotating the frame and the industrial vehicle to transition the industrial vehicle from the laid-over position to the upright position, wherein during the rotating, the curved surface of the heal structure grips the floor surface.
EE. The method of clause DD, wherein the heal structure is adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame.
FF. The method of clause DD or EE, wherein the layover fixture further comprises:
   a second heal structure coupled to the frame and including a curved surface; and
   a second adjustment mechanism associated with the second heal structure for adjusting the position of the second heal structure relative to the frame in the longitudinal direction;
   wherein the two heal structures are respectively coupled to opposed lateral side beams of the frame.
GG. The method of clause FF, wherein during the rotating, the curved surfaces of both of the heal structures grip the floor surface.
HH. The method of clause FF or GG, wherein adjusting the position of the two heal structures relative to the frame comprises rotating a threaded rod of the respective adjustment mechanism to effect movement of the respective heal structure relative to the frame in the longitudinal direction.
II. The method of any of clauses DD-HH, wherein adjusting a position of the heal structure relative to the frame in the longitudinal direction of the frame using the adjustment mechanism is performed prior to providing the layover fixture.
JJ. The method of any of clauses DD-HH, wherein adjusting a position of the heal structure relative to the frame in the longitudinal direction of the frame using the adjustment mechanism is performed after providing the layover fixture.

Having thus described embodiments of the present application in detail and by reference to embodiments thereof, it will be apparent that modifications and variations are possible without departing from the scope of the appended claims.

What is claimed is:

1. A layover fixture for transitioning an industrial vehicle between an upright position and a laid-over position comprising:
a frame that supports the industrial vehicle in the laid-over position on a floor surface, the frame defining a longitudinal direction and a lateral direction transverse to the longitudinal direction;
a heal structure coupled to the frame and including a curved surface for gripping the floor surface while the layover fixture is being used to transition the industrial vehicle between the upright position and the laid-over position; and
an adjustment mechanism associated with the heal structure, the adjustment mechanism for adjusting a position of the heal structure relative to the frame in the longitudinal direction of the frame.

2. The layover fixture of claim 1, wherein;
the adjustment mechanism comprises a threaded rod coupled to the heal structure and an adjustment portion for rotating the threaded rod to adjust the position of the heal structure relative to the frame in the longitudinal direction of the frame; and
the heal structure includes a recess for receiving an end portion of the threaded rod of the adjustment mechanism.

3. The layover fixture of claim 1, wherein the adjustment mechanism is positioned within a recess of the frame such that the adjustment mechanism does not protrude beyond the outer contour of the frame.

4. The layover fixture of claim 1, further comprising:
a second heal structure coupled to the frame, the second heal structure including a curved surface for gripping the floor surface while the layover fixture is being used to transition the industrial vehicle between an upright position and a laid-over position;
a second adjustment mechanism associated with the second heal structure, the second adjustment mechanism for adjusting a position of the second heal structure relative to the frame in the longitudinal direction of the frame;
wherein the two heal structures are respectively coupled to opposed lateral sides of the frame.

5. The layover fixture of claim 4, wherein the two adjustment mechanisms are positioned within recesses provided in respective laterally outer first and second side beams of the frame such that the two adjustment mechanisms do not protrude beyond the outer contour of the frame, and

6. The layover fixture of claim 4, wherein the two heal structures are adjustable in the longitudinal direction of the frame independently of each other via the respective adjustment mechanisms.

7. The layover fixture of claim 1, wherein the curved outer surface of the heal structure comprises an insert for gripping the floor surface while the layover fixture is being used to transition the industrial vehicle between an upright position and a laid-over position.

8. The layover fixture of claim 1, wherein the heal structure is adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame.

9. The layover fixture of claim 1, wherein the frame comprises:
a first laterally outer side beam extending in the longitudinal direction;
a second laterally outer side beam extending in the longitudinal direction and opposed from the first laterally outer side beam in the lateral direction;
a plurality of cross beams extending in the lateral direction between the first and second laterally outer side beams;
a first support portion that supports a body portion of the industrial vehicle; and
a second support portion that supports a mast assembly of the industrial vehicle, the second support portion raised from the first support portion in a third direction that is transverse to the longitudinal direction and to the lateral direction;
wherein the heal structure is coupled to an end portion of the first laterally outer side beam of the frame.

10. The layover fixture of claim 9, wherein the layover fixture further comprises:
a second heal structure coupled to an end portion of the second laterally outer side beam of the frame, the second heal structure including a curved surface for gripping the floor surface while the layover fixture is being used to transition the industrial vehicle between an upright position and a laid-over position; and
a second adjustment mechanism associated with the second heal structure, the second adjustment mechanism for adjusting a position of the second heal structure relative to the frame in the longitudinal direction of the frame.

11. The layover fixture of claim 1, wherein the heal structure is generally centered along a lateral axis of the frame that extends in the lateral direction of the frame.

12. The layover fixture of claim 1, further comprising at least one of:
a plurality of stacking caps for stacking a second layover fixture on top of the layover fixture when the layover fixture is not being used to support an industrial vehicle;
a pair of fork pockets for receiving forks of a transporting vehicle that is used to move the layover fixture from a first location to a second location; or
an accessory support structure for securing spare parts or accessories associated with the industrial vehicle to the layover fixture.

13. The layover fixture of claim 1, further comprising one or more support areas on the frame for receiving dunnage for supporting portions of the industrial vehicle when the industrial vehicle is supported in the laid-over position on the frame.

14. A method for transitioning an industrial vehicle from an upright position to a laid-over position comprising:
providing a layover fixture comprising:
a frame defining a longitudinal direction and a lateral direction transverse to the longitudinal direction;
a heal structure coupled to the frame and including a curved surface; and
an adjustment mechanism associated with the heal structure;
securing the industrial vehicle to the frame while the industrial vehicle is in the upright position;
adjusting a position of the heal structure relative to the frame in the longitudinal direction of the frame using the adjustment mechanism; and
rotating the frame and the industrial vehicle to transition the industrial vehicle from the upright position to the laid-over position such that the industrial vehicle is supported on a floor surface on the frame, wherein during the rotating, the curved surface of the heal structure grips the floor surface.

15. The method of claim 14, wherein:
the heal structure is adjustable from a retracted position, wherein an inner surface of the heal structure is adjacent to an edge of a plate structure of the frame, through an extended position, wherein the inner surface of the heal structure is distal from the edge of the plate structure of the frame in the longitudinal direction of the frame; and
the adjustment mechanism is used to adjust the position of the heal structure back to the retracted position once the industrial vehicle is transitioned to the laid-over position.

16. The method of claim 14, wherein adjusting the position of the heal structure relative to the frame comprises rotating a threaded rod of the adjustment mechanism to effect movement of the heal structure relative to the frame in the longitudinal direction.

17. The method of claim 14, wherein the layover fixture further comprises:
a second heal structure coupled to the frame and including a curved surface; and
a second adjustment mechanism associated with the second heal structure for adjusting the position of the second heal structure relative to the frame in the longitudinal direction;
wherein the two heal structures are respectively coupled to opposed lateral side beams of the frame, and during the rotating, the curved surfaces of both of the heal structures grip the floor surface.

18. A method for transitioning an industrial vehicle from a laid-over position to an upright position comprising:
providing a layover fixture comprising:
a frame defining a longitudinal direction and a lateral direction transverse to the longitudinal direction, wherein the frame supports the industrial vehicle on a floor surface while the industrial vehicle is in the laid-over position;
a heal structure coupled to the frame and including a curved surface; and
an adjustment mechanism associated with the heal structure;
adjusting a position of the heal structure relative to the frame in the longitudinal direction of the frame using the adjustment mechanism; and
rotating the frame and the industrial vehicle to transition the industrial vehicle from the laid-over position to the upright position, wherein during the rotating, the curved surface of the heal structure grips the floor surface.

19. The method of claim 18, wherein the layover fixture further comprises:
a second heal structure coupled to the frame and including a curved surface; and
a second adjustment mechanism associated with the second heal structure for adjusting the position of the second heal structure relative to the frame in the longitudinal direction;
wherein:
the two heal structures are adjustable from a retracted position, wherein an inner surface of the two heal structures is adjacent to an edge of a plate structure of the frame, through an extended position, wherein the inner surface of the two heal structures is distal from the edge of the plate structure of the frame in the longitudinal direction of the frame; and
the two heal structures are respectively coupled to opposed lateral side beams of the frame, and during the rotating, the curved surfaces of both of the heal structures grip the floor surface.

20. The method of claim 19, wherein adjusting the position of the two heal structures relative to the frame comprises rotating a threaded rod of the respective adjustment mechanism to effect movement of the respective heal structure relative to the frame in the longitudinal direction.
